(19) United States
(12) Patent Application Publication
(10) Pub. No.: US 2021/0296055 A1
(43) Pub. Date: Sep. 23, 2021

(54) CAPACITOR ELECTRODE FOIL AND CAPACITOR

(71) Applicant: Nippon Chemi-Con Corporation, Shinagawa-ku, Tokyo (JP)

(72) Inventors: Keita YAJIMA, Tokyo (JP); Yoshiki CHIKYU, Tokyo (JP); Tomoya SASAKI, Tokyo (JP); Satoru TSUMEDA, Tokyo (JP)

(21) Appl. No.: 16/624,857

(22) PCT Filed: May 29, 2018
(86) PCT No.: PCT/JP2018/020610

§ 371 Date: Dec. 19, 2019

(30) Foreign Application Priority Data
Jun. 20, 2017 (JP) 2017-120915

(51) Int. Cl. H01G 11/28; H01G 11/50

(52) U.S. Cl. CPC H01G 11/28; H01G 11/50

(57) ABSTRACT

A capacity deterioration caused when charging and discharging cycles are repeated in a capacitor that includes a polarizable electrode is suppressed. An electrode foil includes a collector 7 and an electrode active substance layer 3. The electrode active substance layer 3 is formed on a surface of the collector 7. This electrode active substance layer 3 is divided by a dividing portion 32 into a plurality of small regions 31. The electrode foil is applicable for a positive electrode foil, or the positive-electrode foil and a negative-electrode foil, and suppresses a capacity deterioration in an electric double-layer capacitor or in a hybrid capacitor.

### TECHNICAL FIELD

The present disclosure relates to an electrode foil for a capacitor and the capacitor which includes an electrode active substance layer like a polarizable electrode.

### BACKGROUND ART

An electric double-layer capacitor is formed by filling an electrolyte between a pair of polarizable electrodes. A hybrid capacitor includes a polarizable electrode at the positive-electrode side, and includes a layer of metal compound particles or a carbon material capable of absorbing and storing, or releasing lithium ions at the negative-electrode side. Both the electric double-layer capacitor and the hybrid capacitor utilize the electricity storing function of the electric double-layer formed in a boundary surface between the polarizable electrode and the electrolyte. Note that the hybrid capacitor has the negative electrode that is a faradaic-reaction electrode.

When the capacitor that has such a polarizable electrode is charged, charged particles are aligned at the boundary surface between the polarizable electrode and the electrolyte. In the positive electrode, anions of the electrolyte are aligned at the boundary surface with the polarizable electrode, and form respective pairs with pores in the polarizable electrode with a quite short distance. Hence, a potential barrier is formed on the positive electrode. In the case of the electric double-layer capacitor, also in the negative electrode, cations of the electrolyte are aligned at the boundary surface with the polarizable electrode, form respective pairs with the electrons in the polarizable electrode with a quite short distance from, and thus a potential barrier is formed on the negative electrode.

As described above, the capacitor that utilizes the electric double-layer physically stores electric charge without using a chemical reaction for charging and discharging, but. Hence, the capacitor that utilizes the electric double-layer has little deterioration of the structural material, and has an excellent charging and discharging cycle lifetime. Therefore, the capacitors that utilize the electric double-layer are often adopted for the purpose of reducing a replacement frequency and of maintenance-free in an application or at an installation location where a constant component exchange is difficult.

### CITATION LIST

### Patent Literatures

[Patent Document 1] JP H11-145015 A

### SUMMARY OF INVENTION

### Technical Problem

According to the keen researches by the inventors of the present disclosure, as a float test for electric double-layer capacitors, even if a DC voltage of 2.5 V was continuously applied for substantially 1400 hours under a temperature circumstance at which the temperature was 30° C., no remarkable capacity deterioration was observed, but when charging and discharging of the electric double-layer capacitor were repeated, the capacity gradually decreased, and when 40000 times of the charging and discharging cycle was exceeded, a phenomenon such that the capacity decreased by 20% in comparison with the initial capacity was observed.

Hence, in order to address the above-described technical problems, an objective of the present disclosure is to provide an electrode foil for a capacitor and the capacitor which suppress a deterioration in capacity by a charging and discharging cycle.

### Solution to Problem

The inventors of the present disclosure manufactured two wound-type electric double-layer capacitors, carried out a charging and discharging cycle test for 40000 times on the first electric double-layer capacitor, and carried out a float test for 5000 hours on the second electric double-layer capacitor. Then, for respective polarizable electrodes of the first and second electric double-layer capacitors at the positive-electrode side, respective polarizable electrodes thereof at the negative-electrode side, and respective separators, an ion concentration (M) at each of three sites was quantitatively determined. The ion concentration was the concentration of either cationic species in an electrolytic solution or anionic species therein, and varied depending on whether the quantitative determination site was the positive electrode, the negative electrode, or the separator.

In this case, the wound-type electric double-layer capacitor included a cylindrical capacitor element. This cylindrical capacitor element was formed by stacking a positive-electrode foil and a negative-electrode foil on each other with the separator being held therebetween, and winding in a spiral shape around a winding axis. Electrode terminals were drawn out from one end face of the cylindrical capacitor element. The sites where the ion concentration (M) was quantitatively determined were, when the cylindrical capacitor element was equally divided into three pieces along a cylindrical axis, a site in the vicinity of the cylindrical axis upper portion (an upper region below) connected to the end face where the electrode terminals were drawn, a site in the vicinity of the cylindrical axis middle portion (a middle region below), and a site in the vicinity of the cylindrical axis lower portion (a lower region below) connected to the opposite end face to the end face where the electrode terminals were drawn. The results are shown in Table 1. The unit of each numeric value is M (mol/L).

TABLE 1

| | | Positive | Negative |
|---|---|---|---|
| | | Electrode | Electrode |
| After Cycle | Upper Region | 0.353 | 0.067 |
| Test | Middle Region | 1.334 | 1.981 |
| | Lower Region | 0.212 | 0.151 |
| Initial Stage | Upper Region | 0.751 | 0.765 |
| | Middle Region | 0.785 | 0.730 |
| | Lower Region | 0.771 | 0.714 |
| After Float | Upper Region | 1.019 | 1.046 |
| Test | Middle Region | 1.037 | 0.991 |
| | Lower Region | 1.030 | 1.042 |

As shown in table 1, in the initial stage prior to the charging and discharging cycle test and to the float test, the upper region, the lower region, and the lower region had the similar ion concentrations. After the charging and discharging cycle test for 40000 times, however, the ion concentrations of the upper region and of the lower region became low in comparison with the initial stage, and the ion concentration of the middle region became high in comparison with the initial stage. That is, it was found that, when charging and discharging were repeated, ions moved from the upper region and from the lower region to the middle region, and an ion concentration gradient was caused within the electric double-layer capacitor. Note that after the float test, no ion concentration gradient was caused.

The inventors of the present disclosure thought that, when charging and discharging were repeated, the ion concentration gradient was caused, and there was a region where the amount of ions was low in a boundary surface between the polarizable electrode and the electrolyte. The capacity produced at a region where the amount of ions was low was small, and consequently, it was thought that a capacity deterioration occurred as a whole capacitor.

Hence, an electrode foil for a capacitor according to the present disclosure includes:

a collector;

an electrode active substance layer formed on a surface of the collector; and

a dividing portion that divides the electrode active substance layer into small regions.

When the electrode active substance layer is divided into the small regions, the movement of ions between the small regions is suppressed, and thus an occurrence of an ion concentration gradient is suppressed.

The electrode active substance layer may be formed in a strip shape, the dividing portion may be a trench which extends in a strip lengthwise direction of the electrode active substance layer, and which divides the electrode active substance layer into the small regions in a strip shape extending along the strip lengthwise direction, and the small region may have a length in a strip widthwise direction along a direction orthogonal to the dividing portion which is 30 mm or more and is 50 mm or less. The ion concentration gradient caused in the same small region can be eased, and the region where the capacity becomes small can be minimized.

The electrode active substance layer may be formed in a strip shape, and the dividing portion may be a trench which extends in a strip lengthwise direction of the electrode active substance layer, and which divides the electrode active substance layer into the small regions in a strip shape extending along the strip lengthwise direction, and which has a width of 1 mm or more. The movement of ions between the small regions can be effectively suppressed, and a reduction in surface area of the electrode active substance layer can be suppressed to the minimum.

The electrode active substance layer may be formed in a strip shape, and the dividing portion may extend along the strip lengthwise direction of the electrode active substance layer. The movement of ions from the upper region to the middle region, and from the lower region to the middle region can be suppressed.

According to another aspect of the present disclosure, a capacitor includes:

the above-described capacitor electrode foil; and

electrolytic solution.

For example, an electric double-layer capacitor that includes the polarizable electrodes on both the positive electrode and the negative electrode, and a hybrid capacitor which has the polarizable electrode at the positive-electrode side, and which has, at the negative-electrode side, an electrode that is a layer of metal compound particles which absorbs, stores, and releases lithium ions are also embodiments of the present disclosure.

According to such a capacitor, the capacitor electrode foil may be provided at only a positive-electrode side. When the electrode active substance layer of the electrode foil at the positive-electrode side is divided into the small regions by the dividing portion, the difference in ion concentration was suppressed even at the electrode active substance layer at the negative-electrode side that had no dividing portion. Needless to say, the capacitor electrode foil may be provided at, at least the positive-electrode side, and the capacitor electrode foil may be provided on both the positive electrode and the negative electrode.

Moreover, the capacitor electrode foil that includes the dividing portion may be provided at the positive-electrode side, and the small region at the positive-electrode side may be covered by an active substance layer of the opposing negative electrode. Furthermore, the respective capacitor electrode foils each including the dividing portion may be provided on both the positive electrode and the negative electrode, a width of the small region of the positive electrode may be narrower than a width of the small region of the negative electrode, and the small region of the positive electrode may be covered by the small region of the opposing negative electrode. The non-opposing region that does not directly face the electrode active substance layer at the negative-electrode side can be eliminated at the positive-electrode side, and thus a capacity deterioration can be further suppressed.

Furthermore, the capacitor may further include:

a capacitor element which has the capacitor electrode foil wound via a separator, and in which electrolytic solution is impregnated;

an outer casing that retains therein the capacitor element; and

a depressed portion that depresses a side face of the outer casing to fasten the capacitor element.

The depressed portion may be formed at a position of the small region which is different from a position of the dividing portion. The depressed portion catches the capacitor element well, and the capacitor element does not become unstable within the outer casing. Hence, the dividing portion does not affect an antivibration performance.

### Advantageous Effects of Invention

According to the present disclosure, even if the capacitor is repeatedly charged and discharged, a deterioration in capacity is suppressed.

### BRIEF DESCRIPTION OF DRAWINGS

FIGS. 1A and 1B are diagrams illustrating a structure of a positive-electrode foil according to an embodiment;

FIG. 2 is an exemplarily diagram illustrating a positional relationship between the positive-electrode foil and a negative-electrode foil;

FIG. 3 is an exemplarily diagram illustrating a condition in which a capacitor is swaged;

FIGS. 4A and 4B are exemplarily diagrams illustrating respective quantitative determination site for ion concentration according to a first example and to a first comparative example;

FIGS. 5 A and 5B are graphs illustrating ion concentration distribution of the respective electric double-layer capacitor according to the first example and to the first comparative example;

FIG. 6 is a graph illustrating a capacity change rate ΔCap (%) at each charging and discharging cycle on the electric double-layer capacitor according to the first example and to the first comparative example;

FIG. 7 is a graph illustrating a capacity change rate ΔCap (%) at each charging and discharging cycle on the electric double-layer capacitor according to the first example, a 12th example, and the first comparative example.

### DESCRIPTION OF EMBODIMENTS

An electrode foil for a capacitor and the capacitor provided with the same according to an embodiment will be described in detail below with reference to the accompanying drawings. Note that the present disclosure is not limited to the embodiment to be described below.

(Entire Structure)

A capacitor includes a positive-electrode foil, a negative-electrode foil, and respective layers of an electrode active substance contained in the respective foils, and utilizes the electricity storing function of an electric double-layer formed in a boundary surface between a polarizable electrode of at least one of the positive-electrode foil or of the negative-electrode foil and an electrolytic solution. Typically, this capacitor is an electric double-layer capacitor or a hybrid capacitor. The electric double-layer capacitor has the respective polarizable electrodes in both the positive-electrode foil and the negative-electrode foil. The hybrid capacitor has the polarizable electrode in the positive-electrode foil, and has a layer of the electrode active substance formed of metal compound particles capable of absorbing, storing, and releasing lithium ions, or a faradaic-reaction electrode formed of a carbon material. An example shape of the capacitor is a wound shape or a laminated shape. In the following description, a wound shape capacitor will be exemplified.

Such capacitors include the positive-electrode foil, the negative-electrode foil, a separator, and the electrolytic solution. The positive-electrode foil, the negative-electrode foil, and the separator are each in a strip shape. The Positive-electrode foil and the negative-electrode foil are laminated with each other with the separator therebetween, and are wound in such a way that the elongated direction of the strip forms a circumference, and thus a cylindrical capacitor element is formed. The electrolytic solution is impregnated in this capacitor element. Note that as long as the electrolyte can be held, a medium is not limited to a liquid, and a solid polymer or a gel electrolyte may be applicable as the electrolytic solution.

(Electrode Foil)

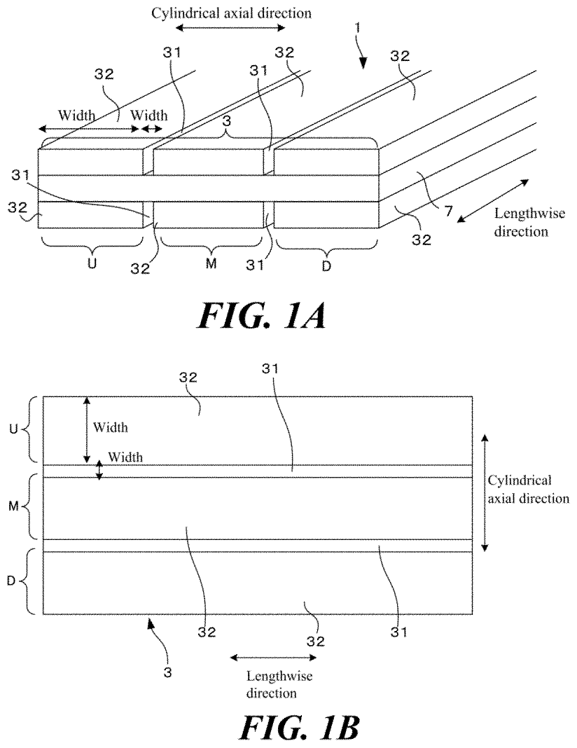

FIGS. 1A and 1B are exemplarily diagrams illustrating an electrode foil 1, and FIG. 1A is a cross-sectional perspective view, while FIG. 1B is a plan view. As illustrated in FIG. 1, the electrode foil 1 that becomes a positive-electrode foil or a negative-electrode foil is formed by forming an electrode active substance layer 3, such as a polarizable electrode or a faradaic-reaction electrode, on a collector 7. The collector 7 is a metal that has a valve action, such as aluminum, platinum, gold, nickel, titanium, and steel. The collector 7 can be in any arbitrary shape, such as a film, a foil, and a plate. Further, the surface of the current collector 7 may be formed with an uneven surface by etching process or the like, or may be a plain surface. Furthermore, a surface treatment may be performed to cause phosphorous to be attached to the surface of the current collector 7.

The electrode foil 1 can be formed by, for example, preparing a mixture of an electrode material which is the material of the electrode active substance layer 3, such as a carbon material that employs a porous structure or a fiber structure which has an electric double-layer capacity, metal compound particles or a carbon material that causes a faradaic-reaction, and a conductive aid, mixing a binder to the mixture, kneading those materials, and shaping the kneaded substance in a sheet. Moreover, the electrode may be formed by applying a mixture liquid of the electrode material, the conductive aid, and binder on the collector 7 by a doctor blade method, etc., and drying those materials. The electrode foil 1 may be also formed by shaping an obtained disperse material into a predetermined shape, pressure bonding the shaped material on the collector 7. It is desirable that the electrode foil 1 should have a thickness of 20 to 150 μm.

Example binders applicable are rubbers, such as fluorine-based rubber, diene-based rubber, and styrene-based rubber, fluorine-containing polymers, such as polytetrafluoroethylene, and polyvinylidene fluoride, celluloses, such as carboxymethylcellulose, and nitrocellulose, and other examples include a polyolefin resin, a polyimide resin, an acrylic resin, a nitrile resin, a polyester resin, a phenol resin, a polyvinyl acetate resin, a polyvinyl alcohol resin, and an epoxy resin. These binders may be used independently or two or more kinds thereof may be mixed and applied.

Example conductive aids applicable are ketjen black, acetylene black, nature/artificial graphite, and fibrous carbon. Example fibrous carbons are carbon nanotube and carbon nano fiber (a CNF below). The carbon nanotube may be a single-walled carbon nanotube (SWCNT) that has a single layer of graphene sheet, or a multi-walled carbon nanotube (MWCNT) in which two or more layers of graphene sheet are rounded concentrically, and a tube wall forms a multiple layers, or may be a combination thereof.

A typical example material of the electrode active substance layer 3 in the polarizable electrode is carbon powders. The conductive aid may be added to the carbon powders. The carbon powders may be subjected to activatory processes, such as water vapor activation, alkali activation, zinc-chloride activation, and electric-field activation, and also opening process. Example carbon powders applicable are a natural plant tissue of palm, etc., a synthetic resin like phenol, activated carbon made from fossil fuels, such as coal, coke, and pitch, carbon black, such as Ketjen black, acetylene black, and channel black, carbon nanohorn, amorphous carbon, natural graphite, artificial graphite, graphitized Ketjen black, activated carbon, and mesoporous carbon.

The electrode active substance layer 3 in a faradaic-reaction electrode is formed by forming a layer using metal compound particles or a carbon material.

Example metal compound particle layers are capable of absorbing, storing and releasing lithium ions, such as oxidation products including FeO, Fe₂O₃, Fe₃O₄, MnO, MnO₂, Mn₂O₃, Mn₃O₄, CoO, CO₃O₄, NiO, Ni₂O₃, TiO, TiO₂, TiO₂ (B), CuO, NiO, SnO, SnO₂, SiO₂, RuO₂, WO, WO₂, WO₃, MoO₃, and ZnO, metals including Sn, Si, Al, and Zn, composite oxides including LiVO₂, Li₃VO₄, Li₄Ti₅O₁₂, Sc₂TiO₅, Fe₂TiO₅, LiFePO₄ and Li₃V₂(PO₄)₃, nitrides including Li_{2.6}Co_{0.4}N, Ge₃N₄, Zn₃N₂, and Cu₃N, Y₂Ti₂OS₂, and MoS₂. Moreover, example carbon materials applicable are black lead (graphite), non-graphitizable carbon (hard carbon), and coke.

When the faradaic-reaction electrode is applied for the negative-electrode foil of a hybrid capacitor, it is desirable that such an electrode should have no through-hole which penetrates the collector 7 of the positive-electrode foil and the electrode active substance layer 3 thereof, and have no through-hole which penetrates the collector 7 of the negative-electrode foil and the carbon material layer thereof.

A carbon-coating layer that contains a conductive agent like graphite may be provided between the collector 7 and the electrode active substance layer 3. The carbon-coating layer can be formed by applying slurry that contains the conductive agent like graphite, the binder, etc., to the surface of the collector, and by drying those.

Dividing portions 31 each extending straightly along one side of the electrode foil 1 is provided in the electrode active substance layer 3. The dividing portion 31 is a thin-line region where the material of the electrode active substance layer 3 is not present from the layer surface of the electrode active substance layer 3 to the layer bottom thereof, and the collector 7 or the carbon-coating layer is exposed, and completely cuts the electrode active substance layer 3 from end to end. The electrode active substance layer 3 is divided into a plurality of strip-shape small regions 32 by the dividing portions 31. A connection between the small regions 32 is lost by the dividing portion 31.

This dividing portion 31 is a trench or a recess part where a single strip or a plurality of strips is extended in parallel. The electrode active substance layer 3 is divided into two or more strips which are the small regions 32 in accordance with the number of the dividing portions 31. For example, the dividing portions 31 are formed with two strips along a belt lengthwise direction of the positive-electrode foil, and the small regions 32 are arranged side by side in the orthogonal direction to the belt lengthwise direction, divided into an upper region U, a middle region M, and a lower region D in the cylindrical axial direction, and extended in parallel with each other. This dividing portion 31 may be formed by not applying, beforehand, the slurry of electrode active substance layer 3 to the region that becomes the dividing portion 31, or by not joining the sheets of the electrode active substance layer 3. In addition, a part of the electrode active substance layer 3 formed on the collector 7 may be eliminated by laser, brush, and other mechanical schemes to form the dividing portion.

According to the electrode active substance layer 3 that has the dividing portions 31, it becomes difficult by the dividing portion 31 for ions in the electrode active substance layer 3 to move across the small regions 32. Hence, within the electrode active substance layer 3, the ion concentration gradient that spreads in the direction orthogonal to the dividing portion 31 is suppressed. Accordingly, within the electrode active substance layer 3, a region where the ion concentration is low is not likely to be created, and thus the capacity deterioration of the capacitor 1 is suppressed. Moreover, since the width of the small region 32 that is a single strip becomes narrow in comparison with the entire width of the electrode active substance layer 3, a difference in ion concentration is also not likely to occur within the small region 32 that is a single strip. Therefore, a region where the ion concentration is low is not likely to be created within the small region 32 that is a single strip, and thus the capacitance deterioration of the capacitor 1 is suppressed.

It is desirable that the total area Y of the small regions 32 occupied in an entire area X of the electrode active substance layer 3 should be equal to or greater than Y=(0.8/0.9)X. First, when the dividing portion 31 is provided, a capacity maintaining rate becomes substantially 90% (in a first example to be described later, the capacity maintaining rate decreases for 8%, and becomes 92%). Second, the dividing portion 31 does not contribute to the capacity of the capacitor 1. Third, when there is no dividing portion 31, the capacity maintaining rate of the capacitor 1 decreases to substantially 80%. Thus the total area Y of the small regions 32 attains an increased capacity of the capacitor that has the capacity deterioration because of the absence of the dividing portion 31.

The length of the dividing portion 31 is from one end of the electrode active substance layer 3 to the other end thereof, and the desirable width of the dividing portion 31 is 1 mm or more. In other words, the adjoining small regions 32 are spaced apart from each other at a pitch of 1 mm or more.

When the pitch is 1 mm or more, the movement of the ions within the electrode active substance layer 3 can be effectively suppressed. However, 3 mm or more is desirable in view of actual manufacturing. Moreover, although the wider the width of the dividing portion 31 is, the better the suppression effect for the capacity deterioration becomes, if it exceeds 6 mm, the total area Y of the small regions 32 becomes difficult to satisfy Y=(0.8/0.9)X.

The desirable width of the small region 32 is 20 mm or more, and 50 mm or less. The term width of the small region 32 is, in the small region 32 belonging to an end of the electrode active substance layer 3, from the end of the electrode active substance layer 3 to the dividing portion 31, and in the small region 32 belonging to the internal side of the electrode active substance layer 3, between the dividing portions 31. Even if the width of the small region 32 exceeds 50 mm, the suppression effect on the capacity deterioration by the dividing portion 31 is accomplished, but such an effect gradually decreases. Moreover, if it becomes smaller than 20 mm, the total area Y of the small region 32 becomes difficult to satisfy Y=(0.8/0.9)X.

It is appropriate that, in the capacitor, the electrode active substance layer 3 of at least the positive-electrode foil is divided into the small regions 32 by the dividing portion 31. Needless to say, the electrode active substance layer 3 of the negative-electrode foil may include the small regions 32 and the dividing portion 31. However, it is presumed that the cause is to maintain electrical neutrality, it is found that when one electrode active substance layer 3 of the positive-electrode foil or the negative-electrode foil is composed of the divided portion 31 and the small region 32, Even if the divided portion 31 is not formed in the other electrode active substance layer in3, the ion concentration difference in the other electrode active substance layer 3 is suppressed.

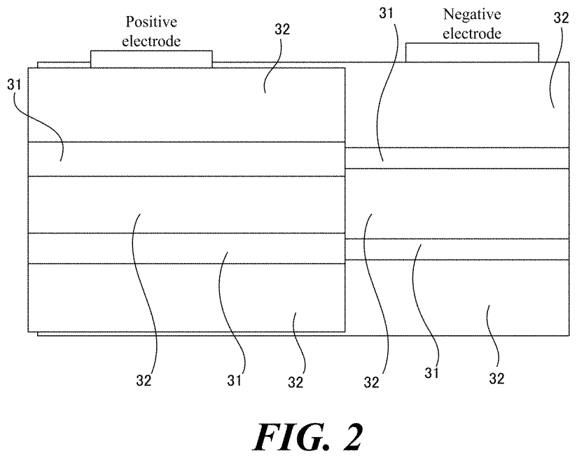

FIG. 2 is an exemplarily diagram illustrating the positional relationship between the positive-electrode foil and the negative-electrode foil. As illustrated in FIG. 2, when the dividing portions 31 are to be formed in the electrodes 3 of both the positive-electrode foil and the negative-electrode foil, the small region 32 of the negative-electrode foil is formed to be wider than the small region 32 of the positive-electrode foil, and the small region 32 of the positive-electrode foil is covered by the small region 32 of the negative-electrode foil so as not to protrude therefrom. That is, it is desirable not to form a region of the electrode 3 of the positive-electrode foil which does not directly face the electrode 3 of the negative-electrode foil. This is because to suppress an oxidation deterioration of a non-opposing region that does not directly face the electrode 3 of the negative-electrode foil.

(Electrolytic Solution)

The electrolytic solution is a mixture liquid obtained by dissolving a solute in a solvent, or further by adding an additive thereto. The ion concentration of the solute of this electrolytic solution is set to 1.0 to 3.0 (M), enabling the ion concentration after the charging and discharging cycle test to be maintained at a predetermined quantity. Example solvents applicable are cyclic carbonates, such as ethylene carbonate, propylene carbonate, vinylene carbonate, butylene carbonate, 4-fluoro-1,3-dioxolane-2-one, and 4-(trifluoromethyl)-1,3-dioxolane 2-one, chain carbonates, such as dimethyl carbonate, ethyl-methyl carbonate, diethyl carbonate, methyl-n-propyl carbonate, methyl-isopropyl carbonate, n-butyl-methyl carbonate, diethyl carbonate, ethyl-n-propyl carbonate, ethyl-isopropyl carbonate, n-butyl-ethyl carbonate, di-n-propyl carbonate, di-isopropyl carbonate, di-n-butyl carbonate, fluoro-ethyl-methyl carbonate, di-fluoro-ethyl-methyl carbonate, tri-fluoro-ethyl-methyl carbonate, chain sulfones, such as ethyl-isopropyl-sulfone, ethyl-methyl-sulfone and ethyl-isobutyl-sulfone, sulfolane, 3-methyl-sulfolane, γ-butyrolactone, acetonitrile, 1,2-di-methoxy-ethane, N-methyl-pyrolidone, di-methyl-formamide, di-methyl sulfoxide, tetra-hydrofuran. 2-methyl-tetra-hydrofuran, 1,3-dioxolane, nitromethane, ethylene glycol, ethylene-glycol dimethyl ether, ethylene glycol diethyl ether, water, or a combination thereof.

An example solute applicable is quarternary ammonium salt in the case of the electric double-layer capacitor. As for the hybrid capacitor, an example solute applicable is one or more kinds of lithium salts, and quarternary ammonium salt may be added thereto.

Example quarternary ammonium salts applicable are, as cations, tetra-ethyl-ammonium, tri-ethyl-methyl ammonium, di-ethyl-dimethyl ammonium, ethyl-trimethyl ammonium, methyl-ethyl pyrrolidinium, spirobipyrrolidinium, spiro-(N,N′)-bipyrrolidinium, 1-ethyl-3-methylimidazolium, 1-ethyl-2,3-dimethyl-imidazolium, etc., and as anions, BF₄⁻, PF₆⁻, ClO₄⁻, AsF₆⁻, SbF₆⁻, AlCl₄⁻, or RfSO₃⁻, (RfSO₂)₂N⁻, RfCO₂⁻ (where Rf is a fluoro-alkyl group with a carbon number of 1 to 8), etc. In particular, ethy-trimethyl ammonium BF₄, diethyl-dimethyl ammonium BF₄, triethyl-methyl ammonium BF₄, tetraethyl ammonium BF₄, spiro-(N, N′)-bipyrrolidinium BF₄, methyl-ethyl-pyrrolidinium BF₄, ethyl-trimethyl ammonium PF₆, diethyl-dimethyl ammonium PF₆, triethyl-methyl ammonium PF₆, tetraethyl ammonium PF₆, spiro-(N, N′)-bipyrrolidinium PF₆, tetramethyl-ammonium-bis-(oxalate)-borate, ethyl-trimethyl-ammonium-bis-(oxalate)-borate, diethyl-dimethyl-ammonium-bis-(oxalate)-borate, triethyl-methyl-ammonium-bis-(oxalate)-borate, tetraethyl-ammonium-bis-(oxalate)-borate, spiro-(N,N′)-bipyrrolidinium-bis-(oxalate)-borate, tetramethyl-ammonium-difluoro-oxalate-borate, ethyl-trimethyl-ammonium-difluoro-oxalate-borate, diethyl-dimethyl-ammonium-difluoro-oxalate-borate, triethyl-methyl-ammonium-difluoro-oxalate-borate, tetraethyl-ammonium-difluoro-oxalate-borate, and spiro-(N,N′)-bipyrrolidinium-difluoro-oxalate-borate, etc., are preferable.

Example lithium salts applicable are LiPF₆, LiBF₄, LiClO₄, LiN(SO₂CF₃)₂, LiN(SO₂C₂F₅) 2, CF₃SO₃Li, LiC(SO₂CF₃) 3 and LiPF₃ (C₂F₅)₃, or a combination thereof.

Moreover, example additives applicable are phosphoric acids and the derivative thereof (e.g., phosphoric acid, phosphorous acid, phosphoesters and phosphonic acids), boric acid and the derivative thereof (boric acid, oxidation boric acid, borate esters, and a complex of boron and a compound that has a hydroxyl group, and/or a carboxyl group), nitrate salt (lithium nitrate, etc.), and nitro compounds (nitrobenzoic acid, nitrophenol, nitrophenetol, nitroacetophenone, aromatic nitro compound, etc.). In view of the conductivity, it is preferable that the amount of the additive should be 10 wt % or less of the entire electrolyte, and more preferably, 5 wt % or less. Moreover, a gas absorbent may be contained. An absorbent of the gas produced from the electrode is not limited to any particular material as long as it does not react with and does not remove (adsorption, etc.) each component of the electrolyte (a solvent, an electrolyte salt, and various additives, etc.). Specific examples are zeolite, and silica gel, etc.

(Separator)

Example separators applicable are a cellulose-based separator, synthetic-fiber-nonwoven-fabric-based separator, a mixed paper in which cellulose and synthetic fibers are mixed, or a porous film. Example celluloses are a craft, a Manila fiber, esparto, hemp, and rayon, etc. Example nonwoven fabrics are fibers of polyester, polyphenylene sulfide, polyethylene terephthalate, polybutylene terephthalate, polyamide, polyimide, a fluorine resin, polyolefin-based resins, such as polypropylene and polyethylene, ceramics, and glass.

(Assembling Method)

An assembling method of such a capacitor is as follows. First, a positive-electrode foil, a negative-electrode foil, and a separator are laminated on each other with the lengthwise direction of the strips and the widthwise direction thereof being aligned with each other. The separator is held between the positive-electrode foil and the negative-electrode foil. The positive-electrode foil, the negative-electrode foil, and the separator are wound in a spiral shape around a winding axis, and thus a capacitor element in a cylindrical shape is formed. Electrode terminals connected to the positive-electrode foil and to the negative-electrode foil, respectively, are drawn out from one end face of the cylindrical body.

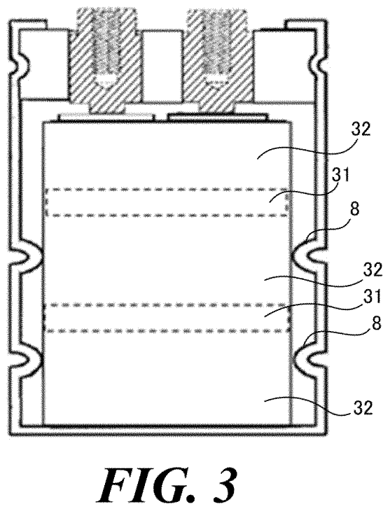

Electrolytic solution is impregnated in the capacitor element, and the capacitor element in which the electrolytic solution is impregnated is inserted in an outer casing in a cylindrical shape that has a bottom. The outer casing is sealed with a sealing rubber by swaging. That is, as illustrated in FIG. 3, the outer casing is swaged, thereby fastening the capacitor element to the outer casing. A depressed portion 8 is a protrusion that protrudes toward the capacitor element by swaging of the outer casing, bites into the capacitor element, thereby fastening the capacitor element to the outer casing.

The depressed portion 8 is formed at a location directed toward the small region 32. In other words, the depressed portion 8 is formed so as to avoid the dividing portion 31. No electrode active substance layer 3 is present at the location of the dividing portion 31. Hence, the capacitor element is softened at the location of the dividing portion 31, and even if the depressed portion 8 is formed at the dividing portion 31, the fastening of the capacitor element becomes unstable. Moreover, regarding the dividing portion 31, since the electrode active substance layer 3 does not become a reinforcement, when the depressed portion 8 is provided at the dividing portion 31, stress of the depressed portion 8 is concentrated on the collector 7, causing an increase in resistance such that the collector 7 is excessively elongated.

In contrast, when the depressed portion 8 is provided so as to be directed toward the small region 32, the capacitor element is stabilized within the outer casing, and thus antivibration performance is improved.

### EXAMPLES

The present disclosure will be described in further detail with reference to examples. Note that the present disclosure is not limited to the following examples.

### First Example

The positive-electrode foil and the negative-electrode foil were laminated on each other with the separator being held therebetween, and those were wounded to form a cylindrical capacitor element. The electrolytic solution was impregnated in this cylindrical capacitor element, and an electric double-layer capacitor according to a first example was manufactured. The details are as follows.

That is, relative to 100 pts·wt. of a vapor-activated active carbon, 9 pts·wt. of carbon black, 2 pts·wt. of carboxymethylcellulose as a dispersant, 2 pts·wt. of SBR emulsion as a binder, and pure water were mixed to each other to obtain slurry.

Moreover, an etching-processed aluminum foil was soaked in a phosphoric-acid aqueous solution to cause phosphorous to be attached on the surface of the foil, a coating material containing black lead was applied to the surface of the foil to form respective carbon-coating layers on both surfaces of the aluminum foil, and thus the collector 7 was manufactured. The collector 7 was in a strip shape. The collector 7 of the positive-electrode foil had a width of 144 mm in a cylindrical axial direction orthogonal to the lengthwise direction of the strip, and the collector 7 of the negative-electrode foil had a width of 146 mm in the cylindrical axial direction orthogonal to the lengthwise direction of the strip.

The slurry with a width of 40 mm in the cylindrical axial direction was applied to the collector 7 of the positive-electrode foil along the lengthwise direction of the collector 7. This slurry was applied by three strips parallel to each other with a pitch of 7 mm therebetween in the cylindrical axial direction. Next, the slurry was dried. That is, the electrode active substance layer 3 formed on the collector 7 of the positive-electrode foil was divided into respective small regions 32 that were the upper region U, the middle region M, and the lower region D each having a width of 40 mm, by the two dividing portions 31 each having a width of 7 mm.

In contrast, the slurry with a width of 42 mm in the cylindrical axial direction was applied to the collector 7 of the negative-electrode foil along the lengthwise direction of the collector 7. This slurry was applied by three strips parallel to each other with a pitch of 5 mm therebetween in the cylindrical axial direction. Next, the slurry was dried. That is, the electrode active substance layer 3 formed on the collector 7 of the negative-electrode foil was divided into the respective small regions 32 that were the upper region U, the middle region M and the lower region D each having a width of 42 mm, by the two dividing portions 31 each having a width of 5 mm.

Subsequently, respective center lines of the positive-electrode foil and the negative-electrode foil were aligned with the cellulose-based separator being present therebetween, and the positive-electrode foil and the negative-electrode foil were laminated on each other in such a way that the small region 32 of the positive-electrode foil was completely covered by the small region 32 of the negative-electrode foil, and wounded. The electrolytic solution was impregnated in the cylindrical capacitor element. The applied electrolytic solution was methyl-ethyl-pyrrolidinium BF₄/propylene-carbonate solution of 1.5 M. Moreover, electrode terminals were drawn out from respective one end faces of the positive-electrode foil and the negative-electrode foil. Next, this cylindrical capacitor element was put into the outer casing with a dimension of 40 ϕ×170 L, and sealed by a sealer, and the depressed portion 8 was formed at the location toward the small region 32. Hence, an electric double-layer capacitor according to the first example was produced.

### First Comparative Example

An electric double-layer capacitor according to a first comparative example differs from the electric double-layer capacitor according to the first example such that no dividing portion 31 was formed. That is, the slurry with a width of 144 mm was applied to the collector 7 of the positive-electrode foil with a width of 144 mm, and dried. That is, the electrode active substance layer 3 that was continuous over a width of 144 mm was applied by a strip on the collector 7 of the positive-electrode foil. Moreover, the slurry with a width of 146 mm was applied on the collector 7 of the negative-electrode foil with a width of 146 mm, and dried. That is, the electrode active substance layer 3 that was continuous over a width of 146 mm was applied by a strip on the collector 7 of the negative-electrode foil. Other than that, the electric double-layer capacitor of the first comparative example was manufactured by the same composition, production method and condition as those of the first example.

(Ion Concentration Distribution Check)

After repeating the charging and discharging of the respective electric double-layer capacitors of the first example and of the first comparative example, and completing the charging and discharging cycle test for 40000 times, the ion concentration distribution in the electrode active substance layer 3 of the positive-electrode foil was checked. This cycle test had a cycle which included a charging to a rated voltage, and a discharging to ½ of the rated voltage at a room temperature, and repeated such a cycle. Regarding a current value, a discharging current value was decided at the rate of substantially 30 mA per an electrostatic capacitance 1 F.

In order to measure the ion concentration distribution, the following method was adopted. That is, the electric double-layer capacitor was decomposed, and the wounded positive-electrode foil was opened. The vicinity of the center of the positive electrode foil was cut along the cylindrical axial direction, i.e., cut in a widthwise direction orthogonal to the lengthwise direction, and a rectangular measurement piece was cut out. The measurement piece was cut out in such a way that one side thereof was aligned with the cylindrical axial direction of the positive-electrode foil, and a side adjacent to this one side had a length of 5 cm or more, preferably, 10 cm or more. This measurement piece was further cut in extraction regions (nine sites) to be described later, each extraction region was soaked in an acetonitrile solution at a room temperature for 12 hours to extract the electrolytic solution, and each electrolytic solution extracted from each region was diluted 1000 times with pure water by. Next, each diluted solution was made as a sample, and the ion concentration was subjected to quantitative determination by chromatography.

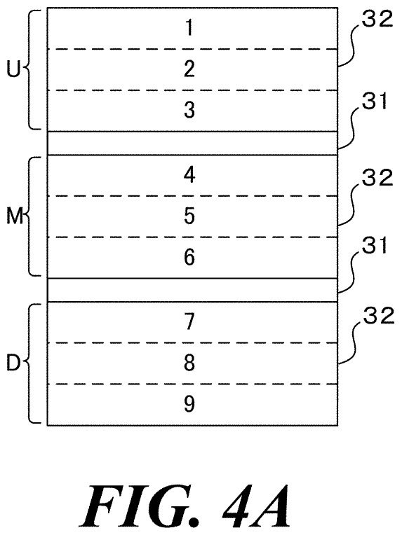

As illustrated in FIG. 4A, in the first example, three extraction sites were set for each of the small regions 32 that were the upper region U, the middle region M, and the lower region D. The three extraction sites set in the small region 32 that was a strip were arranged side by side at an equal pitch in the widthwise direction of the small region 32, i.e., the cylindrical axial direction. That is, as for the first example, the electrolytic solution was extracted from a total of nine sites. Respective extraction sites are numbered from 1 to 9 in a sequence from the side at which the electrode terminal was drawn out.

The first to third extraction sites belongs to the upper region U of the small region 32, and are arranged in sequence from the side at which the electrode terminal was drawn out in an ascending order of numbers. The fourth to sixth extraction sites belongs to the middle region M of the small region 32, and arranged in sequence from the side at which the electrode terminal was drawn out in an ascending order of numbers. The seventh to ninth extraction sites belongs to the lower region D of the small region 32, and arranged in sequence from the side at which the electrode terminal was drawn out in an ascending order of numbers.

Moreover, as illustrated in FIG. 4B, regarding the first comparative example, the electrolytic solution was extracted from a total of three sites. The respective extraction sites correspond to the second, fifth, and eighth sites in the first example. The second site is the center of the upper region U, the fifth site is the center of the middle region M, and the eighth site is the center of the lower region D.

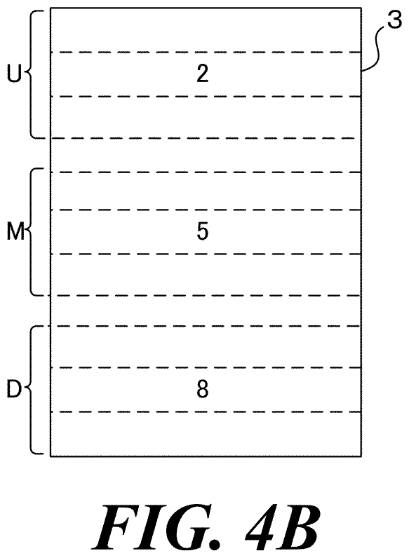

FIGS. 5A and 5B are graphs indicating the ion concentration distributions of the respective electric double-layer capacitor of the first example and of the first comparative example. In FIG. 5A, the first to ninth extraction sites in the first example are arranged side by side along the horizontal axis, and the ion concentration is indicated along the vertical axis. In FIG. 4B, the first to ninth extraction sites in the first comparative example are arranged side by side along the horizontal axis, and for the second, fifth, and eighth extraction sites among those, the respective ion concentrations are plotted.

As illustrated in FIG. 5B, according to the electric double-layer capacitor of the first comparative example, the ion concentration was substantially 1.4 M at the fifth extraction site, was substantially 0.2 M at the second extraction site, and was substantially 0.4 M at the eighth extraction site. The ion concentration of the middle region M increased, but the ion concentrations of the upper region U and of the lower region D decreased, and the difference was increased to substantially 1.2 M.

In contrast, as illustrated in FIG. 5A, according to the electric double-layer capacitor of the first example, the average of the ion concentrations at the first to third extraction sites was substantially 0.7 M, the average of the ion concentrations at the fourth to sixth extraction sites was substantially 0.7 M, and the average of the ion concentrations at the seventh to ninth extraction sites was substantially 0.9 M. That is, it is confirmed that, when the electrode active substance layer 3 is divided into the plurality of small regions 32 by the dividing portion 31, the difference in ion concentration of the upper region U and the lower region D from the middle region M was suppressed to substantially 0.2 M.

Moreover, as illustrated in FIG. 5A, according to the electric double-layer capacitor of the first example, the respective ion concentrations of the first to third extraction sites were 0.7 M, 0.9 M, and 0.5 M, and the ion concentration gradient in the small region 32 of the upper region U became gentle. In addition, the ion concentrations of the fourth to sixth extraction sites were 0.5 M, 1.0 M, and 0.65 M, and the ion concentration gradient in the small region 32 of the middle region M became gentle. Furthermore, the ion concentrations of the seventh to ninth extraction sites were 0.7 M, 1.2 M, and 0.8 M, and the ion concentration gradient in the small region 32 of the lower region D also became gentle. That is, it is confirmed that, by narrowing the width of the small region 32 even within the small region 32 that is a strip, the difference in ion concentration was suppressed.

Furthermore, according to the electric double-layer capacitor of the first comparative example, the ion concentration of the second extraction site was 0.2 M which was a quite small value, but according to the electric double-layer capacitor of the first example, the ion concentration at any extraction site, i.e., the concentration of either the cationic species or the anionic species of the electrolytic solution showed a value that exceeds 0.3 M, indicating that the effect on the characteristic deterioration can be reduced.

(Capacity Change Rate Check)

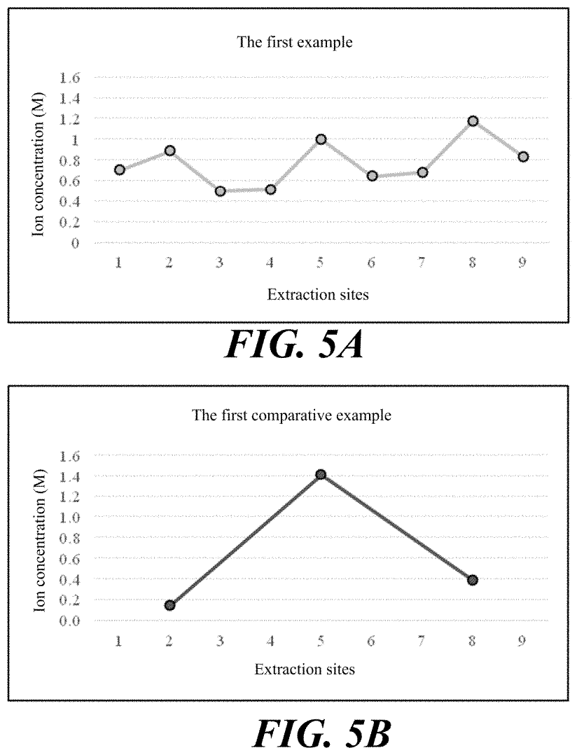

The charging and discharging of the respective electric double-layer capacitors of the first example and of the first comparative example were repeated. During this charging and discharging cycle test, a capacity change rate ΔCap (%) at each charging and discharging cycle relative to an initial capacity was measured. The results are shown in FIG. 6. As shown in FIG. 6, according to the electric double-layer capacitor of the first comparative example, every time the number of cycles increased, the capacity decreased, and the capacity deterioration reached 20% at the time point at which 40000 cycles were accomplished. In contrast, according to the electric double-layer capacitor of the first example, it is same as the first comparative example in that the capacity decreased every time the number of cycles increased, but after 10000 and several 1000 cycles, the capacity decrease became gentle, and the capacity deterioration was maintained at substantially 8.5% at the time point at which 40000 cycles were accomplished.

It is confirmed that, in view of the above results for the ion concentration and for the capacity change rate, by dividing the electrode active substance layer 3 into the small regions 32 by the dividing portion 31, the ion concentration difference within the capacitor 1 is eased, the ion concentration that is at least 0.3 M or more can be maintained, and the capacity deterioration is suppressed.

### Second Example

According to an electric double-layer capacitor of a second example, in the positive-electrode foil of the electric double-layer capacitor according to the first example, the width of the small region 32 of the electrode active substance layer 3 was 30 mm, the width of the dividing portion 31 was 5 mm, and in the negative-electrode foil, the width of the small region 32 of the electrode active substance layer 3 was 32 mm, and the width of the dividing portion 31 was 3 mm. The width of the positive-electrode foil was 100 mm, and the width of the negative-electrode foil was 102 mm. Other than those, the same material, method and condition as those of the first example were adopted for manufacture.

### Third Example

According to an electric double-layer capacitor of a third example, in the positive-electrode foil of the electric double-layer capacitor according to the first example, the width of the small region 32 of the electrode active substance layer 3 was 40 mm, and the width of the dividing portion 31 was 5 mm, and, in the negative-electrode foil, the width of the small region 32 of the electrode active substance layer 3 was 42 mm, and the width of the dividing portion 31 was 3 mm. The width of the positive-electrode foil was 130 mm, and the width of the negative-electrode foil was 132 mm. Other than those, the same material, method and condition as those of the first example were adopted for manufacture.

### Fourth Example

According to an electric double-layer capacitor of a fourth example, in the positive-electrode foil of the electric double-layer capacitor according to the first example, the width of the small region 32 of the electrode active substance layer 3 was 50 mm, and the width of the dividing portion 31 was 5 mm, and, in the negative-electrode foil, the width of the small region 32 of the electrode active substance layer 3 was 52 mm, and the width of the dividing portion 31 was 3 mm. The width of the positive-electrode foil was 160 mm, and the width of the negative-electrode foil was 162 mm. Other than those, the same material, method and condition as those of the first example were adopted for manufacture.

### Fifth Example

According to an electric double-layer capacitor of a fifth example, in the positive-electrode foil, the width of the small region 32 of the electrode active substance layer 3 was 60 mm, and the width of the dividing portion 31 was 5 mm, and, in the negative-electrode foil, the width of the small region 32 of the electrode active substance layer 3 was 62 mm, and the width of the dividing portion 31 was 3 mm. The width of the positive-electrode foil was 190 mm, and the width of the negative-electrode foil was 192 mm. Other than those, the same material, method and condition as those of the first example were adopted for manufacture.

### Sixth Example

According to an electric double-layer capacitor of a sixth example, in the positive-electrode foil of the electric double-layer capacitor according to the first example, the width of the small region 32 of the electrode active substance layer 3 was 70 mm, and the width of the dividing portion 31 was 5 mm, and, in the negative-electrode foil, the width of the small region 32 of the electrode active substance layer 3 was 72 mm, and the width of the dividing portion 31 was 3 mm. The width of the positive-electrode foil was 220 mm, and the width of the negative-electrode foil was 222 mm. Other than those, the same material, method and condition as those of the first example were adopted for manufacture.

(Capacity Change Rate Check)

The respective electric double-layer capacitors according to the first to sixth examples were repeatedly charged and discharged. During this charging and discharging cycle test, a capacity change rate ΔCap (%) at each charging and discharging cycle relative to an initial capacity was measured. The results are shown in Table 2.

TABLE 2

| | Small Region | Dividing Portion | |
|---|---|---|---|
| | Width (mm) | Width (mm) | ΔCap (%) |
| Second | 30 | 5 | −10.1 |
| Example | | | |
| Third | 40 | | −8.7 |
| Example | | | |
| Fourth | 50 | | −13.7 |
| Example | | | |
| Fourth | 60 | | −17.2 |
| Example | | | |
| Sixth | 70 | | −19.1 |
| Example | | | |

As shown in Table 2, when charging and discharging were repeated by 40000 cycles, the capacity deterioration was 10.1% for the second example in which the width of the small region 32 was 30 mm, was 8.7% for the third example in which the width of the small region 32 was 40 mm, was 13.7% for the fourth example in which the width of the small region 32 was 50 mm, was 17.2% for the fifth example in which the width of the small region 32 was 60 mm, and was 19.1% for the sixth example in which the width of the small region 32 was 70 mm.

Accordingly, it is confirmed that, when the width of the small region 32 becomes narrow, the capacity deterioration is eased. Moreover, it is confirmed that the capacity reduction becomes gentle around 10000 cycles when the width of the small region 32 is 50 mm or less, remarkably contributing to the suppression effect on the capacity deterioration at a time point at which 40000 cycles are accomplished. Therefore, it is desirable that the width of the small region 32 should be 50 mm or less.

### Seventh Example to 10th Example

According to respective electric double-layer capacitors of seventh to 10th examples, in the positive-electrode foil of the electric double-layer capacitor according to the first example and in the negative-electrode foil thereof, the width of the small region 32 of the electrode active substance layer 3 and the width of the dividing portion 31 thereof were set in dimensions as shown in Table 3 for manufacture. Other than those, the same material, method and condition as those of the first example were adopted for manufacture.

Note that according to the electric double-layer capacitor of the seventh example, the differences from the first example are that the small region 32 at the negative-electrode-foil side was narrower than the small region 32 at the positive-electrode-foil side, and, in the small region 32 at the positive-electrode-foil side, a non-opposing region which did not directly face the small region 32 at the negative-electrode side is presented.

That is, according to the electric double-layer capacitor of the seventh example, a slurry with a width of 40 mm was applied on the collector 7 of the positive-electrode foil at a pitch of 1 mm along the lengthwise direction of the collector 7, and dried. Consequently, the small regions 32 that were three strips with a width of 40 mm width were formed, and the positive-electrode foil in which three strips of the small regions 32 were divided by two strips of the dividing portions 31 with a width of 1 mm was formed.

slurry with a width of 38 mm was applied on the collector 7 of the negative-electrode foil along the lengthwise direction of the collector 7 at a pitch of 3 mm, and dried. Consequently, three strips of the small regions 32 with a width of 38 mm were formed, and the negative-electrode foil in which the three strips of the small regions 32 were divided by two strips of the dividing portions 31 with a width of 3 mm was formed. Therefore, the 2-mm width in the small regions 32 of the positive-electrode foil becomes the non-opposing region which does not directly face the small region 32 of the negative-electrode foil, and for three strips of the small regions 32, a total of a 6-mm non-opposing region is formed.

(Capacity Change Rate Check)

The respective electric double-layer capacitors of the seventh to 10th examples and of the first comparative example were repeatedly charged and discharged. During this charging and discharging cycle test, a capacity change rate ΔCap (%) at each charging and discharging cycle relative to an initial capacity was measured. The results are shown in Table 3.

TABLE 3

| | Small Region | | Dividing Portion | | |
|---|---|---|---|---|---|
| | Width (mm) | | Width (mm) | | |
| | Positive | Negative | Positive | Negative | |
| | Electrode | Electrode | Electrode | Electrode | Δ cap(%) |
| First Comp. | — | | — | | −19.6 |
| Example | | | | | |
| Seventh | 40 | 38 | 1 | 3 | −14.5 |
| Example | | | | | |
| Eighth | 40 | 40 | 3 | 3 | −10.3 |
| Example | | | | | |
| Nineth | 40 | 42 | 5 | 3 | −8.8 |
| Example | | | | | |
| Tenth | 40 | 42 | 11 | 3 | −8.3 |
| Example | | | | | |

As shown in Table 3, when charging and discharging were repeated by 40000 cycles, the capacity deterioration was 19.6% for the first comparative example, was 14.5% for the seventh example in which the width of the dividing portion 31 at the positive-electrode side was 1 mm, was 10.3% for the eight example in which the width of the dividing portion 31 was 3 mm, was 8.8% for the ninth example in which the width of the dividing portion 31 was 5 mm, and was 8.3% for 10th example in which the width of the dividing portion 31 was 11 mm.

Hence, it is confirmed that, when there is the dividing portion 31, the capacity deterioration is suppressed. Next, it is confirmed that, the wider the width of the dividing portion 31 is, the greater the suppression effect on the capacity deterioration becomes. It is thought that when the width of the dividing portion 31 becomes wide, it becomes difficult for ions to move between the small regions 32. Note that it is desirable that the width of the dividing portion 31 should be 3 mm or more in view of variability in manufacture.

Moreover, according to the electric double-layer capacitor of the seventh example, in comparison with the eighth example, the degree of the capacity deterioration is large, and it is thought that the deterioration is caused because of the presence of the non-opposing region in the small region 32 of the positive-electrode foil. It is confirmed that, desirably, the small region 32 of the positive-electrode foil does not have a part which does not directly faces the electrode active substance layer 3 of the negative-electrode foil, i.e., the small region of the positive-electrode foil is covered by the small region of the negative-electrode foil via the separator.

### 11th Example

Electric double-layer capacitors were manufactured in which the respective dividing portions of the positive-electrode foil and of the negative-electrode foil had a width of 6 mm, and the width of the small region of the polarizable electrode at the positive-electrode side and at the negative-electrode side was changed in steps of 10 mm, from 20 mm to 60 mm. The capacity after the charging and discharging cycle test of 40000 cycles was measured. The electric double-layer capacitor was a wound-type electric double-layer capacitor in a dimension of 63.5 #×172 L, had the rated voltage of 2.5 V, and had a rated capacity of 3600 F. The results are shown in Table 4.

TABLE 4

| | Small Region Width (mm) | | | | |
|---|---|---|---|---|---|
| | 20 | 30 | 40 | 50 | 60 |
| 11th | 2.840(F) | 3.010(F) | 3.170(F) | 3.320(F) | 3.330(F) |
| Example | | | | | |

| | |
|---|---|
| First Comp. | 2.880(F) |
| Example | |

Capacity (F) after Charging and Discharging Cycle Test

As shown in Table 4, according to the electric double-layer capacitor of the first comparative example, the capacity became 2880 F by the capacity deterioration after the test of 40000 cycles. In contrast, it becomes clear that, when the width of the small region 32 becomes 30 mm or more, the capacity exceeds 2880 F of the first comparative example. Therefore, it is confirmed that, the width of the small region 32 is desirably 30 mm or more.

### 12th Example

According to an electric double-layer capacitor of an 12th example, although the same dividing portion 31 as that of the first example was provided in the electrode active substance layer 3 of the positive-electrode foil, and same as the first example, the electrode active substance layer 3 was divided in the small regions 32, the difference from the first example was that no dividing portion 31 was provided in the electrode active substance layer 3 of the negative-electrode foil, i.e., the negative-electrode foil of the first comparative example was applied. Other than those, the same material, method and condition as those of the first example were adopted for manufacture.

(Capacity Change Rate Check)

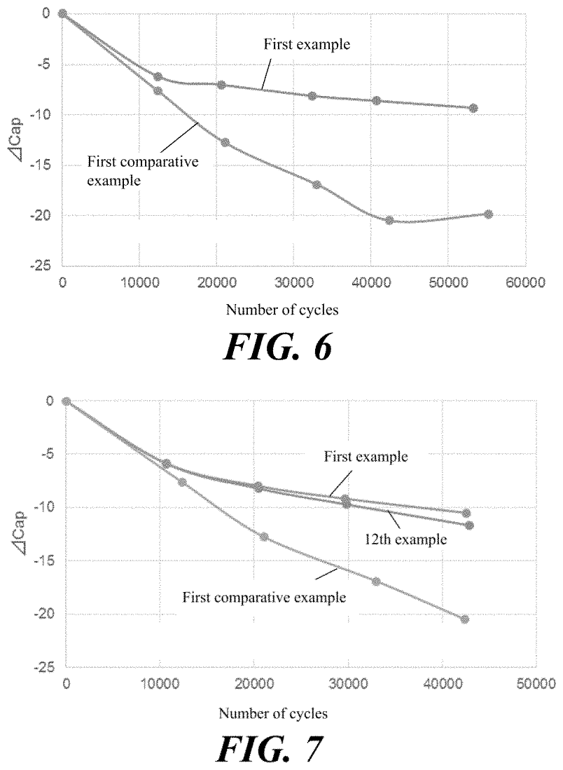

Charging and discharging of the respective electric double-layer capacitors of the first example, the 12th example, and the first comparative example were repeated. During such a charging and discharging cycle test, a capacity change rate ΔCap (%) at each charging and discharging cycle relative to an initial capacity was measured. The results are shown in FIG. 7. As shown in FIG. 7, it is confirmed that the electric double-layer capacitor of the 10th example in which only the electrode active substance layer 3 of the positive-electrode foil is divided into the small regions 32 by the dividing portion 31 was not different from that of the first example, and a pseudo-capacity deterioration was suppressed.

### 13th Example

A hybrid capacitor according to a 13th example and having the dividing portions 31 formed in the positive-electrode foil and in the negative-electrode foil was manufactured. The hybrid capacitor of the 13th example had the same positive-electrode foil as that of the first example, and the numbers and widths of the small regions 32 in the positive-electrode foil and in the negative-electrode foil, and the number and width of the dividing portions 31 were the same as those of the first example. According to the hybrid capacitor of the 13th example, however, the applied negative-electrode foil was a faradaic-reaction electrode that had the electrode active substance layer 3 formed of lithium titanate. An applied electrolytic solution was a propylene carbonate solution which had a solute that was 1.5 M of LiBF₄.

That is, 5 wt % of polyvinylidene fluoride, and a proper amount of N-methyl-pyrrolidone were added to lithium titanate powders, were sufficiently mixed to form a slurry, applied on the collector 7 that was an aluminum foil on which a carbon coating layer is formed on the surface, and dried. Hence, an electrode that contained lithium titanate was obtained.

The slurry which contained lithium titanate was applied on the collector 7 having a width of 146 mm in the cylindrical axial direction and the slurry having a width of 42 mm in the cylindrical axial direction was applied along the longitudinal direction of the current collector 7. This slurry was applied for three strips in parallel to each other at a pitch of 5 mm in the cylindrical axial direction.

That is, the electrode active substance layer 3 formed on the collector 7 of the negative-electrode foil was divided into the respective small regions 32 of the upper region U, the middle region M, and the lower region D each having a width of 42 mm by the two dividing portions 31 with a width of 5 mm.

Note that regarding the positive-electrode foil, three strips were applied in parallel to each other on the collector 7 with a width of 144 mm in the cylindrical axial direction at a pitch of 7 mm in the cylindrical axial direction. That is, the electrode active substance layer 3 formed on the collector 7 of the positive-electrode foil was divided into the respective small regions 32 of the upper region U, the middle region M, and the lower region D each having a width of 40 mm by the two dividing portion 31 with a width of 7 mm.

### Second Comparative Example

A hybrid capacitor of a second comparative example differs from the hybrid capacitor of the 13th example that no dividing portion 31 was formed. Other than that, the same material, method, and condition were adopted to manufacture the hybrid capacitor according to the second comparative example.

(Capacity Change Rate Check)

Charging and discharging of the respective hybrid capacitors of the 13th example and of the second comparative example were repeated. During the charging and discharging cycle test, a capacity change rate ΔCap (%) at each charging and discharging cycle relative to an initial capacity was measured. The results are as follows. That is, according to the hybrid capacitor of the second comparative example, every time the number of cycles increased, the capacity decreased, and the capacity deterioration reached 18.5% at the time point at which 40000 cycles were accomplished. In contrast, according to the hybrid capacitor of the 13th example, the capacity deterioration was maintained at substantially 8.9% at the time point at which 40000 cycles were accomplished.

In view of the above results on the ion concentration distribution and on the capacity change rate, it becomes clear that, by dividing the electrode active substance layer 3 into the small regions 32 by the dividing portion 31, even in the cases of the electric double-layer capacitor and of the hybrid capacitor, the difference in ion concentration is eased, and the capacity deterioration is suppressed.

### REFERENCE SIGNS LIST

1 Electrode Foil
3 Electrode Active substance Layer
31 Dividing Portion
32 Small Region
7 Collector
8 Depressed Portion

1. An electrode foil for a capacitor comprising:
a collector;
an electrode active substance layer formed on a surface of the collector; and
a dividing portion that divides the electrode active substance layer into small regions.

2. The capacitor electrode foil according to claim 1, wherein:
the electrode active substance layer is formed in a strip shape, and is divided, by the dividing portion, into the small regions in a strip shape each extending along a strip lengthwise direction of the electrode active substance layer; and
the small region has a length in a strip widthwise direction along a direction orthogonal to the dividing portion which is 30 mm or more and 50 mm or less.

3. The capacitor electrode foil according to claim 1, wherein:
the electrode active substance layer is formed in a strip shape; and
the dividing portion is a trench which extends in a strip lengthwise direction of the electrode active substance layer, and which divides the electrode active substance layer into the small regions in a strip shape each extending along the strip lengthwise direction, and which has a width of 1 mm or more.

4. A capacitor comprising:
the capacitor electrode foil according to claim 1; and electrolytic solution.

5. The capacitor according to claim 4, wherein an ion concentration (M) at a widthwise end of the strip-shape capacitor electrode foil after 40000 times of a charging and discharging cycle test has elapsed is 0.3 or more.

6. The capacitor according to claim 4, wherein the capacitor electrode foil is provided at, at least a positive-electrode side.

7. The capacitor according to claim 4, wherein the capacitor electrode foil is provided only at the positive-electrode side.

8. The capacitor according to claim 4, wherein:
the capacitor electrode foil that includes the dividing portion is provided at the positive-electrode side; and
the small region at the positive-electrode side is covered by an active substance layer of the opposing negative electrode.

9. The capacitor according to claim 4, wherein:
the respective capacitor electrode foils each including the dividing portion are provided on both the positive electrode and the negative electrode;
a width of the small region of the positive electrode is narrower than a width of the small region of the negative electrode; and
the small region of the positive electrode is covered by the small region of the opposing negative electrode.

10. The capacitor according to claim 4, wherein the respective capacitor electrode foils are applied for both the positive electrode and the negative electrode, and the electrode foils each comprise a polarizable electrode.

11. The capacitor according to claim 4, wherein:
the respective capacitor electrode foils are applied for both the positive electrode and the negative electrode;
the capacitor electrode foil at the positive-electrode side comprises a polarizable electrode; and
the capacitor electrode foil at the negative-electrode side comprises an electrode formed of a layer of metal compound particles that absorbs, stores, or releases lithium ions.

12. The capacitor according to claim 4, comprising:
a capacitor element which has the capacitor electrode foil wound via a separator, and in which electrolytic solution is impregnated;
an outer casing that retains therein the capacitor element; and
a depressed portion that depresses a side face of the outer casing to fasten the capacitor element,
wherein the depressed portion is formed at a position of the small region which is different from a position of the dividing portion.

13. The capacitor electrode foil according to claim 2, wherein:
the dividing portion is a trench which extends in a strip lengthwise direction of the electrode active substance layer, and which divides the electrode active substance layer into the small regions in a strip shape each extending along the strip lengthwise direction, and which has a width of 1 mm or more.

14. A capacitor comprising:
the capacitor electrode foil according to claim 2; and electrolytic solution.

15. A capacitor comprising:
the capacitor electrode foil according to claim 3; and electrolytic solution.

16. A capacitor comprising:
the capacitor electrode foil according to claim 13; and electrolytic solution.

17. The capacitor according to claim 14, wherein an ion concentration (M) at a widthwise end of the strip-shape capacitor electrode foil after 40000 times of a charging and discharging cycle test has elapsed is 0.3 or more.

18. The capacitor according to claim 15, wherein an ion concentration (M) at a widthwise end of the strip-shape capacitor electrode foil after 40000 times of a charging and discharging cycle test has elapsed is 0.3 or more.

19. The capacitor according to claim 16, wherein an ion concentration (M) at a widthwise end of the strip-shape capacitor electrode foil after 40000 times of a charging and discharging cycle test has elapsed is 0.3 or more.
